(19) United States
(12) Patent Application Publication
(10) Pub. No.: US 2019/0381733 A1
(43) Pub. Date: Dec. 19, 2019

(54) Device and Method for Additive Manufacturing

(71) Applicant: Siemens Aktiengesellschaft, München (DE)

(72) Inventors: Yves Küsters, Berlin (DE); Martin Schäfer, Berlin (DE)

(73) Assignee: Siemens Aktiengesellschaft, München (DE)

(21) Appl. No.: 16/480,411

(22) PCT Filed: Dec. 27, 2017
(86) PCT No.: PCT/EP2017/084622

§ 371 Date: Jul. 24, 2019

(30) Foreign Application Priority Data
Jan. 24, 2017 (EP) 17152781.5

(51) Int. Cl. B29C 64/245; B29C 64/295; B29C 64/393; B29C 64/255; B29C 64/153; B22F 3/105; B29C 64/232; B29C 64/236

(52) U.S. Cl. CPC B29C 64/245; B29C 64/295; B29C 64/393; B29C 64/255; B33Y 10/00; B22F 3/1055; B29C 64/232; B29C 64/236; B22F 2003/1058; B29C 64/153

(57) ABSTRACT

A device for the additive manufacturing of a shaped body comprising: a process chamber for a material for making the shaped body; a plurality of bar elements defining at least a partial region of the process chamber, wherein each of the plurality of bar elements is movable in relation to one another; and a sensor associated with at least one of the plurality of bar elements detecting forces and/or torques acting on the at least one bar element.

### CROSS-REFERENCE TO RELATED APPLICATIONS

This application is a U.S. National Stage Application of International Application No. PCT/EP2017/084622 filed Dec. 27, 2017, which designates the United States of America, and claims priority to EP Application No. 17152781.5 filed Jan. 24, 2017, the contents of which are hereby incorporated by reference in their entirety.

### TECHNICAL FIELD

The present disclosure relates to additive manufacturing. Various embodiments may include devices and methods for additive manufacturing.

### BACKGROUND

EP 1669143 A1 describes a device used for additive manufacturing of at least one shaped body and has at least one process chamber for accommodating a material, from which the shaped body is producible or is produced by the additive manufacturing.

### SUMMARY

The teachings of the present disclosure include refined devices and methods providing a particularly advantageous production of a shaped body. For example, some embodiments include a device (10) for the additive manufacturing of at least one shaped body, having at least one process chamber (14) for accommodating a material, from which the shaped body (12) is producible by the additive manufacturing, wherein at least a partial region of the process chamber (14) is delimited by a plurality of bar elements (20, 21), which are at least translationally movable in relation to one another, characterized in that at least one sensor (34) is associated with at least one of the bar elements (20, 21), by means of which forces and/or torques acting on the at least one bar element (20, 21) are detectable.

In some embodiments, the bar elements (20, 21) have a respective longitudinal extension direction and are translationally movable in relation to one another along the respective longitudinal extension direction thereof.

In some embodiments, at least one of the bar elements (20, 21) is designed to at least indirectly support the shaped body (12).

In some embodiments, at least one of the bar elements (20, 21) is designed to control the temperature of the shaped body (12).

In some embodiments, at least one duct extends inside the at least one bar element (20, 21), through which a fluid for the temperature control of the shaped body can flow.

In some embodiments, the at least one bar element (20, 21) is provided with at least one heating element (17), in particular with at least one electric heating element, by means of which the shaped body (12) is heatable.

In some embodiments, a vibration unit (19) is provided, by means of which at least one of the bar elements (20, 21) can be set into vibrations in relation to the process chamber.

In some embodiments, at least one of the bar elements (20, 21) has an end region (31) having a free end (33) protruding into the process chamber, wherein the end region (31) is accommodated in a cap (30, 32).

In some embodiments, the cap (30, 32) is formed from the same material as the material from which the shaped body (12) is producible by the additive manufacturing.

In some embodiments, the sensor (34) is held on the cap (30, 32).

In some embodiments, the sensor (34) detects traction forces.

In some embodiments, the sensor (34) is designed to provide at least one, in particular electric, signal characterizing the detected forces and/or torques, wherein the device (10) has an electronic processing unit (35), which is designed to receive the signal and to move the bar elements (20, 21) in dependence on the signal.

As another example, some embodiments include a method for the additive manufacturing of at least one shaped body (12), during which the shaped body (12) is produced from a material accommodated in a process chamber (14) by additive manufacturing, wherein at least a partial region of the process chamber (14) is delimited by a plurality of bar elements (20, 21), which are moved at least translationally in relation to one another, characterized in that at least one sensor (34) is associated with at least one of the bar elements (20, 21), by means of which forces and/or torques acting on the at least one bar element (20, 21) are detected.

### BRIEF DESCRIPTION OF THE DRAWINGS

Exemplary embodiments of the teachings of the present disclosure a explained in greater detail hereafter on the basis of schematic drawings. In the figures:

FIG. 1 shows a schematic perspective view of a first embodiment of a device incorporating teachings of the present disclosure for the additive manufacturing of a shaped body, wherein at least one partial region of a process chamber is formed by bar elements, which are movable in relation to one another;

FIG. 2 shows a schematic perspective view of a second embodiment incorporating teachings of the present disclosure;

FIG. 3 shows a schematic and lateral perspective view of a bar element of a third embodiment incorporating teachings of the present disclosure;

FIG. 4 shows a schematic and lateral perspective view of a bar element of a fourth embodiment incorporating teachings of the present disclosure;

FIG. 5 shows a detail of a schematic perspective view of a fifth embodiment incorporating teachings of the present disclosure; and

FIG. 6 shows a detail of a schematic perspective view of a sixth embodiment incorporating teachings of the present disclosure.

### DETAILED DESCRIPTION

Some embodiments of the teachings of the present disclosure include a device for the additive manufacturing of at least one shaped body. The device has at least one process chamber for accommodating a material, from which the shaped body is producible or is produced by the additive manufacturing. In some embodiments, at least a partial region of the process chamber is delimited by a plurality of bar elements, which are at least translationally movable in relation to one another.

In some embodiments, during the additive manufacturing, a material bed is formed from the material, for example, from which the shaped body is produced. For example, the material is a powdered material, i.e., a powder, so that the material bed is designed, for example, as a powder bed. The additive manufacturing can thus be powder-bed-based additive manufacturing. During the additive manufacturing, the shaped body is built up, i.e., produced, for example, by means of selective solidification via radiant energy, in particular of a laser beam, layer by layer in the process chamber.

The process chamber can be, for example, the interior of a so-called construction cylinder or a so-called material bed chamber. The material and thus the shaped body may be supported in the process chamber on a suitable lowering device, for example, a construction plate, which forms a bottom of the process chamber. For example, after the production of the respective layer, the construction plate may be lowered to then arrange further material in the process chamber on the construction plate and thus on the already produced layer, from which a further layer of the shaped body is then produced. A buildup in layers of the shaped body is thus provided.

In some embodiments, the volume of the process chamber increases during the additive manufacturing due to lowering of the construction plate. The shaped body sinks surrounded by powder in the process chamber. Support elements, so-called support structures, may be produced by means of the radiant energy from the material during the production of the shaped body, depending on its geometric composition, and thus have to be co-created, since the material bed does not always ensure a sufficient support function for supporting the shaped body during its production.

Furthermore, a very high temperature gradient can occur between powder bed and shaped body and/or also only in the shaped body itself due to the radiant energy. The temperature gradient can result in mechanical tensions in the shaped body, which can possibly make further support structures necessary. The support structures are typically connected to the construction plate and/or to a substrate plate applied to the construction plate. The shaped body itself is typically also connected to this substrate plate. Since the support structures are produced from the same material as the shaped body, the support structures cause an increased material consumption. The production of the support structures is thus time-consuming and costly.

In some embodiments, a device may reduce or avoid these issues because, for example, the bar elements can be used to support the shaped body as needed during its production, without support structures having to be produced from the material for this purpose. The shaped body can thus be produced in a manner favorable to time and costs. Due to the use of the bar elements, the process chamber can be embodied as a modular process chamber or as a modular construction chamber, the interior or inner-peripheral shape of which can be varied and/or set as needed, for example, by moving the bar elements in relation to one another. In particular, the bar elements can be used as simple support structures and/or for influencing the temperature gradients.

In some embodiments, the process chamber and/or its volume is at least partially delimited by a bottom and partially by at least one side wall. For example, the bottom, frequently a so-called construction platform, delimits the process chamber at the bottom in the vertical direction, wherein the side wall at least partially delimits the process chamber in the horizontal direction. The process chamber, which is also referred to as a construction chamber, holds the powdered material for building up the shaped body. The process chamber be a straight circular cylinder. In some embodiments, at least one partial region of the side wall and/or the bottom is formed by the bar elements. In this case, the shape of the process chamber can be varied as needed by moving the bar elements in relation to one another. For example, if the bottom is completely formed from the bar elements, the abovementioned substrate plate and/or construction plate can be omitted.

In some embodiments, the bar elements are movable horizontally and/or vertically in relation to one another. If the bar elements form, for example, a first partial region of the side wall and/or the bottom, wherein the side wall and/or the bottom has at least one second partial region adjoining the first partial region, the bar elements are thus movable, in particular at least translationally, for example, in relation to one another and in relation to the second partial region. The bar elements are formed, for example, cuboid and/or spatulate or round on the outer circumference.

In some embodiments, the bar elements each have a longitudinal extension direction and are translationally movable in relation to one another along the respective longitudinal extension direction thereof. In some embodiments, the bar elements are movably mounted on at least one bearing element and are thus movable in relation to one another and in relation to the bearing element. The volume of the process chamber, via a continuous increase due to the additive manufacturing process itself, is thus variable by the mobility of the bar elements. The volume of the process chamber can thus be kept particularly small, for example, whereby material can be saved during the manufacturing. Due to the possibility of moving the bar elements, they are movable, for example, in a controlled or regulated manner, so that a precisely defined shape of the process chamber is settable, so that it can be adapted to the shaped body to be formed.

In some embodiments, at least one of the bar elements is designed to at least indirectly support the shaped body. Due to the mobility of the at least one bar element, it can be used, by way of suitable positioning in relation to the shaped body, to support the shaped body. For example, for this purpose the at least one bar element functioning as a support element can directly support at least a part of the shaped body. In some embodiments, the at least one bar element can assume an indirect support function, by at least one support structure being additively manufactured from the material, for example, on or at the at least one bar element, so that the shaped body is supported at the at least one bar element with mediation of the support structure manufactured at the at least one bar element. In this case, the expenditure in time, material, and thus costs for manufacturing the support structure on the at least one bar element can be kept low.

In some embodiments, at least one of the bar elements is designed to control the temperature of the shaped body. The at least one bar element is formed, for example, from a material which has a thermal conductivity. For example, due to the thermal conductivity of the material from which the at least one bar element is formed, and due to the option of reducing or canceling out a distance between the at least one bar element and the shaped body by moving the at least one bar element, for example, in such a way that the at least one bar element directly contacts the shaped body, the bar element can be used as a heat bridge and can thus control the temperature of the shaped body. By way of a temperature control of the shaped body, for example, tensions therein, which can occur during the manufacturing, can be reduced or kept low.

The temperature control is to be understood to mean that at least one part of the shaped body can be cooled and/or heated or kept hot by means of the at least one bar element. For example, as a result of a heat transfer from the shaped body to the at least one bar element, the shaped body can be at least partially cooled. Furthermore, it is conceivable to at least partially heat the shaped body by a heat transfer taking place from the at least one bar element to the shaped body.

In some embodiments, at least one duct extends inside the at least one bar element, through which a fluid for the temperature control of the process chamber and/or the shaped body can flow. Influence can be taken particularly well on the temperature gradients in the process chamber, in particular on the shaped body, in this way.

In some embodiments, the at least one bar element is provided with at least one electrical heating element, by means of which the shaped body is heatable. By way of the possibility of being able to move and thus align the bar elements in relation to one another and in relation to the shaped body, for example, a position to be temperature-controlled can be set as needed, in particular in a controlled or regulated manner, at which the shaped body is to be temperature-controlled. The shaped body can thus be manufactured with particularly low tension.

In some embodiments, a vibration unit is provided, by means of which at least one of the bar elements can be set into vibrations in relation to the process chamber. Compacting of the material, in particular the powder bed, in the process chamber can take place due to the vibration. Gas inclusions in the material and/or material bed are kept small due to a more compact powder bed, whereby the demand for support structures can be kept low and an advantageous heat exchange can be implemented. Furthermore, the process stability increases with a compact powder bed and in addition a particularly high shaped body density can be achieved.

In some embodiments, at least one of the bar elements has an end region having a free end protruding into the process chamber, wherein this end region is accommodated in a cap. Local support structures can be created on this cap. Furthermore, the at least one bar element can be protected by means of the cap, in particular from wear and/or damage, so that, for example, only the cap has to be replaced, but not the at least one bar element.

In some embodiments, the cap is formed from the same material as the material from which the shaped body is producible by the additive manufacturing. A connection and/or support of the shaped body on the cap can be achieved due to the material equivalence, possibly via support structures, whereby, for example, a particularly good thermal connection of the shaped body to the bar element is possible.

In some embodiments, at least one sensor is associated with at least one of the bar elements, by means of which forces and/or torques acting on the at least one bar element are detectable. Monitoring of the manufacturing process can thus be implemented, for example, so that a particularly high level of process stability can be displayed.

In some embodiments, the sensor is held on the cap. Thus, for example, more direct feedback of procedures inside the process chamber can be possible in comparison to a sensor attached to the bar element, if the bar element is provided with a cap on its free end protruding into the process chamber. Furthermore, for example, the bar element can be equipped with different sensors in a simple manner, by caps having different sensors being arranged on the bar element.

In some embodiments, the sensor is designed to detect traction forces. Traction forces act during the manufacturing of the shaped body, for example, because of the deformation of the shaped body generated by the deposition of the radiant energy of the laser beam and the temperature gradients accompanying this. Since the traction forces can be transmitted to the bar elements, possibly via support structures, the sensor is a particularly practical option for detecting tension in the shaped body.

In some embodiments, the sensor is designed to provide at least one, in particular electric, signal characterizing the detected forces and/or torques, wherein the device has an electronic processing unit, which is designed to receive the signal and to move the bar elements in dependence on the signal. By analyzing the signal by means of the electronic processing unit and by processing this signal by way of the processing unit, for example, at least one of the bar elements are moved so that a measured force influence acting thereon can be counteracted or compensated as much as possible and the efficiency of the support structures formed on the bar element can thus be increased and tensions in the shaped body can be reduced. For example, the sensor is designed as a strain gauge.

Some embodiments include a method for the additive manufacturing of a shaped body, in particular by means of a device as described above. During the method, at least one partial region of a process chamber for accommodating a material, from which the shaped body is formed, is delimited by a plurality of bar elements, which are at least translationally movable or can be moved in relation to one another. The shaped body can thus be particularly produced during its buildup by means of additive manufacturing. In particular, a particularly high quality of the shaped body can be implemented. The embodiments of the device are to be considered to be embodiments of the methods and vice versa.

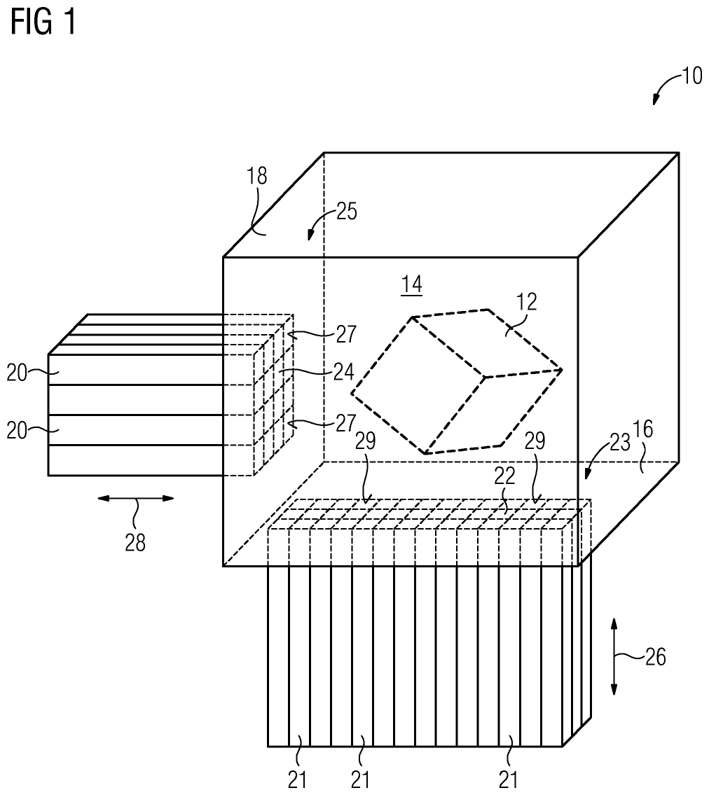

FIG. 1 shows a schematic perspective view of a first embodiment of a device 10 for the additive manufacturing of a shaped body 12. The shaped body 12 is produced in a process chamber 14, which is delimited on the bottom by a bottom 16 of the device 10, in particular in the vertical direction. Furthermore, the process chamber 14 is delimited in the horizontal direction at least on one side by a side wall 18 of the device 10. In this case, a material (not shown in greater detail in the figures) is accommodated in the process chamber, wherein the shaped body 12 is produced from the material by additive manufacturing, i.e., by means of an additive manufacturing method.

To produce the shaped body 12, bar elements 21, which are designed here as cuboid on the outer circumference, for example, form a partial region 22 of the bottom 16. Furthermore, bar elements 20 form a partial region 24 of the side wall 18. In this case, the bar elements 20 have respective longitudinal extension directions, which coincide here with the horizontal or the horizontal direction, respectively. Moreover, the bar elements 21 have respective longitudinal extension directions, which coincide with the vertical or the vertical direction, respectively, and accordingly extend perpendicularly to the longitudinal extension direction of the bar elements 20. The bar elements 21 forming the partial region 22 move in relation to one another in the vertical direction.

In some embodiments, a partial region 23 of the bottom 16 adjoins the partial region 22 formed by the bar elements 21, wherein the partial region 23 partially delimits the process chamber 14 on the bottom in the vertical direction. In this case, the bar elements 21 are translationally movable in relation to the partial region 23 along the respective longitudinal extension direction thereof.

Moreover, the bar elements 20 forming the partial region 24 are translationally movable in relation to one another along the respective longitudinal extension direction thereof. A partial region 25 of the side wall 18 adjoins the partial region 24 formed by the bar elements 20, wherein the partial region 25 partially delimits the process chamber 14 in the horizontal direction. In this case, the bar elements 20 are translationally movable along the respective longitudinal extension direction thereof in relation to the partial region 25.

During the additive manufacturing, the shaped body 12 is built up layer by layer in the process chamber 14, for example, by means of selective solidification via radiant energy, in particular of a laser beam. Respective layers are produced from the, for example, powdered material, in particular metal powder, and at least partially arranged one over another and/or on one another. For this purpose, the entire bottom 16 is typically lowered step-by-step before or after the production of the respective layer of the shaped body 12, whereby the process chamber 14 forms and its volume increases. In this case, the process chamber 14 accommodates the material, for example, powder, from which the shaped body 12 is formed or produced.

By moving the bar elements 20 and 21, they can be moved into respective different positions. In FIG. 1, the positions of the bar elements 20 and 21 are such that they delimit the process chamber 14 in such a way that it is cuboid on the interior circumference thereof. In this case, respective end faces 27 of the bar elements 20 facing toward the process chamber 14 are arranged at equal height along the horizontal direction and thus flush in relation to one another. Furthermore, the end faces 27 are arranged at equal height along the horizontal direction as the partial region 25 and thus flush with the partial region 25. Moreover, respective end faces 29 of the bar elements 21 facing toward the process chamber 14 are arranged at equal height along the vertical direction and thus flush in relation to one another. Furthermore, the end faces 29 are arranged at equal height along the vertical direction as the partial region 23 and thus flush with the partial region 23. The horizontal direction is a first movement direction 28, along which the bar elements 20 are movable translationally in relation to one another and in relation to the partial region 25. The vertical direction is a second movement direction 26, along which the bar elements 21 are movable translationally in relation to one another and in relation to the partial region 23.

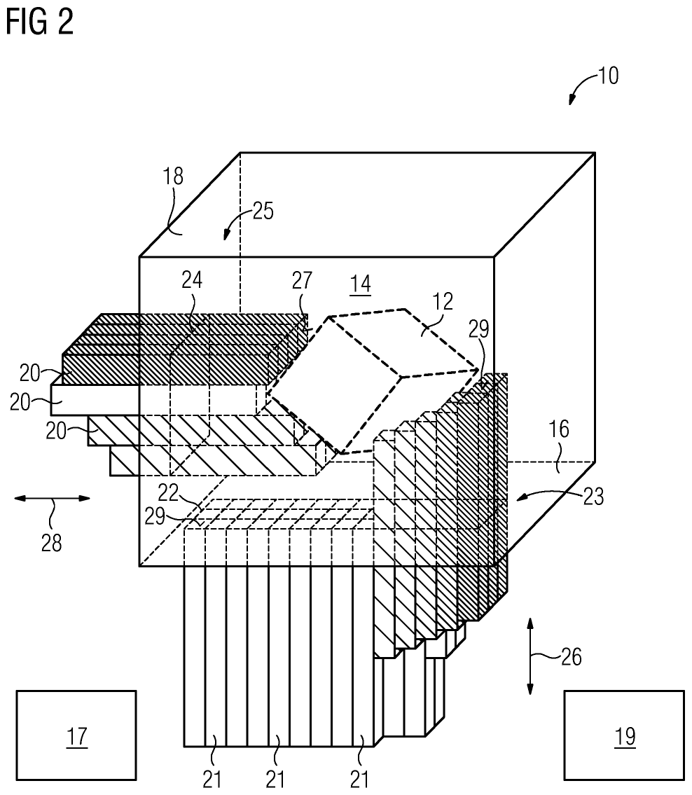

FIG. 2 shows a schematic perspective view of a second embodiment of the device 10, which is used as an example of a configuration option of the process chamber 14 and its volume, as can be achieved by positioning of the bar elements 20 and 21. In this case, at least a part of the bar elements 20 and 21 is moved along the respective movement direction 26 or 28 thereof, respectively, such that they extend as close as possible to the shaped body 12 and possibly contact it. In this way, the shaped body 12 can be supported during its production. In some embodiments, the volume of the process chamber 14 can be kept particularly small, whereby material can be saved during the buildup of the shaped body 12. The bar elements 20 and 21 may be arranged according to FIG. 2 so that they mutually overlap and/or are overlaid along the movement direction 26 and/or 28. This is shown in FIG. 2 in that a first part of the bar elements 21 are positioned on the shaped body 12 and contact and support it, while a second part of the bar elements 20 remain in the base position thereof, i.e., the second part is positioned so that the respective end faces 29 of the second part are located in a common plane with the partial region 23. It can be advisable in this case to move the bar elements 20 and 21 as close as possible to the shaped body, to thus keep the volume of the process chamber as small as possible, whereby material can be saved.

In some embodiments, the bar elements 20 and 21 can function as support elements and thus as so-called support structures, by means of which the shaped body 12 is at least indirectly supportable. Depending on the shape of the shaped body 12, at least a part of the bar elements 20 and/or at least a part of the bar elements 21 are positioned on the shaped body 12 and at least indirectly support it.

In some embodiments, at least one of the bar elements 20 and/or 21 is designed for the purpose of controlling the temperature of the shaped body 12, e.g., cooling and/or heating it. In some embodiments, a duct (not shown) extends in the at least one bar element, through which a fluid can flow. The fluid can be controlled in temperature, for example, by means of at least one temperature-control unit. For example, as a result of a heat transfer from the fluid to the at least one bar element, the at least one bar element is heated. A heat transfer can then take place from the at least one bar element to the shaped body 12, whereby the shaped body 12 is heated.

In some embodiments, a heat transfer can furthermore take place from the shaped body 12 via the at least one bar element to the fluid, whereby the shaped body 12 is cooled and the fluid is heated. The fluid can then be cooled again, for example, by means of the temperature-control unit.

In some embodiments, the at least one bar element is provided with at least one, in particular electric, heating element 17, by means of which the shaped body 12 can be heated, in particular via the at least one bar element. In particular, it is conceivable to be able to control the temperature of multiple or all of the bar elements 20 and/or 21, to thus be able to control the temperature of the shaped body 12. Thus, for example, a temperature of the shaped body 12 can be set, in particular regulated or controlled. In this way, the shaped body 12 can be cooled down particularly strongly and rapidly, for example. It is thus possible, for example, to remove the shaped body 12 particularly rapidly from the device 10 and thus enable a particularly high throughput, i.e., a particularly high piece number per time interval. In this way, a particularly high productivity can be implemented, and the costs can be kept particularly low.

In some embodiments, there may be simultaneous heating and cooling. In this case, for example, a respective first partial region of the shaped body 12 is heated by means of a first part of the bar elements 20 and/or 21, while a respective second partial region of the shaped body 12, which is different from the first partial region, is cooled by means of a second part of the bar elements 20 and/or 21. With respect to the bar elements 21, it is provided, for example, that the farther downward a bar element 21 is located, the lower its temperature is set and a respective part of the shaped body 12 located in the vicinity of the respective bar element 21 accordingly cools down faster and/or is heated less strongly. A temperature gradient of the shaped body 12 and/or in the process chamber 14 can thus be set. With corresponding temperature control of the individual bar elements 20 and/or 21, a particularly high or low temperature gradient can thus be implemented on the shaped body 12 and/or in the process chamber 14. In this way, for example, excess tensions in the shaped body 12 can be avoided. Depending on the type and shape of the shaped body 12 to be formed by the additive manufacturing, the temperature gradient can be set as needed by the device 10. Different temperatures of the respective temperature-controlled bar elements 20 and/or 21 are shown by different shadings in FIG. 2. The closer together the bars of the shading are, the higher the temperature is set on the bar element 20 and/or 21. No shading means that the temperature is not regulated or is not actively set in the example on this bar element 20 and/or 21.

In some embodiments, the device 10 furthermore comprises a vibration unit 19, which can set the bar elements 20 and/or 21 into motion along the respective translational movement direction thereof in such a way that these bar elements vibrate. The material, in particular metal powder, which is used for the production of the shaped body 12 can thus be solidified and/or compacted.

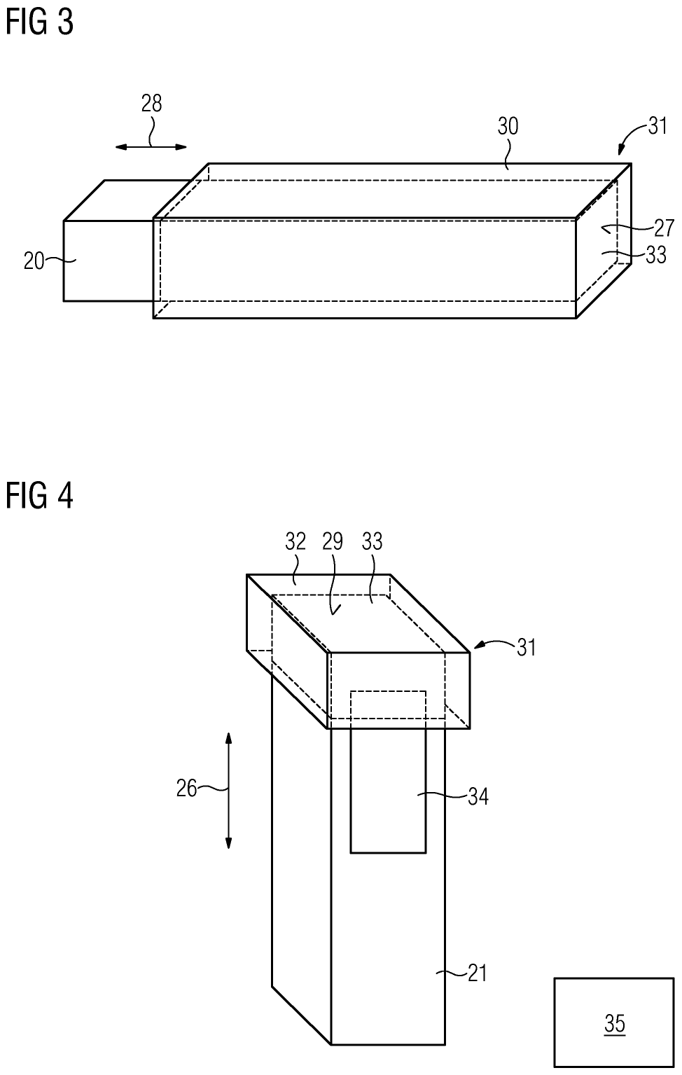

FIG. 3 shows a schematic and lateral perspective view of one of the bar elements 20, which is translationally movable along the horizontal movement direction 28, of a third embodiment of the device. The bar element 20 is at least predominantly enclosed by a cap 30, i.e., accommodated in the cap 30.

FIG. 4 shows a schematic and lateral perspective view of one of the bar elements 21 for a fourth embodiment, which is translationally movable along the vertical movement direction 26. In this case, the bar element 21 has an end region 31 having a free end 33 protruding into the process chamber 14, wherein the end region 31 is accommodated in a cap 32. Moreover, a sensor 34, which is arranged and/or held on the bar element 21, is associated with the bar element 21 according to FIG. 4. This sensor 34 is designed here, for example, as a strain gauge and can detect traction forces which act on the bar element 20. In some embodiments, the sensor 34 can be replaced particularly easily, i.e., can be installed easily on or removed from the bar element, and nonetheless has a particularly good connection to the bar element in this case, for example, by way of a soldered-on plate.

In some embodiments, the sensor 34 detects forces and/or torques which act on the respective bar element 20 and/or 21. In this case, the sensor 34 provides, for example, an, in particular electric, signal characterizing the detected forces or torques. For example, an electronic processing unit 35 is provided, which is connected to the sensor 34 in such a way that the processing unit 35 can receive the signal. As a result, for example, the bar elements 20 and 21 can be moved by means of the processing unit 35 in dependence on the signal along the respective movement direction 26 or 28, respectively. Furthermore, it is conceivable that the sensor 34 is held on the cap 32, so that the sensor 34 is replaceable with the cap 32, for example. Alternatively, the sensor 34 can be designed to detect a temperature of the respective bar element 20 or 21 and/or of the shaped body 12 and to provide at least one, in particular electric, signal characterizing the detected temperature. The shaped body 12 can thus be temperature-controlled by means of the processing unit 35 in dependence on the signal.

The caps 30 and 32 shown in FIG. 3 and FIG. 4 can protect the respective bar element 20 or 21 covered thereby from soiling and wear. For example, the shaped body 12 is supportable via the caps 30 and 32 on the bar elements 20 and 21. The caps 30 and 32 may be easily replaced on the bar element 20 or 21, respectively, to enable rapid cleaning of the process chamber 14, for example, and/or the caps 30 and/or 32 can be adapted to a new material for the shaped body 12 to be formed.

In some embodiments, during the production of the shaped body 12 the caps 30 and 32 may be formed from the same material as the shaped body 12 itself and/or are formed from the same material as the material. Thus, for example, support structures which are to support the shaped body 12 can be produced from the material, in particular by additive manufacturing, and can be connected particularly stably to the respective cap 30 and/or 32 and thus to the respective bar element 20 and/or 21.

If a particularly effective dissipation of temperature from the process chamber 14 is desirable during the production of the shaped body 12, for example, caps 30 and/or caps 32 may be made of a material having a particularly high coefficient of thermal conduction. Furthermore, it is conceivable to produce the caps 30 and/or 32 from a particularly cost-effective material. Different bar elements 20 and/or 21 can also be covered by caps 30 and/or 32 made of different materials in each case during the additive manufacturing of a specific shaped body 12, in order to combine the abovementioned advantages.

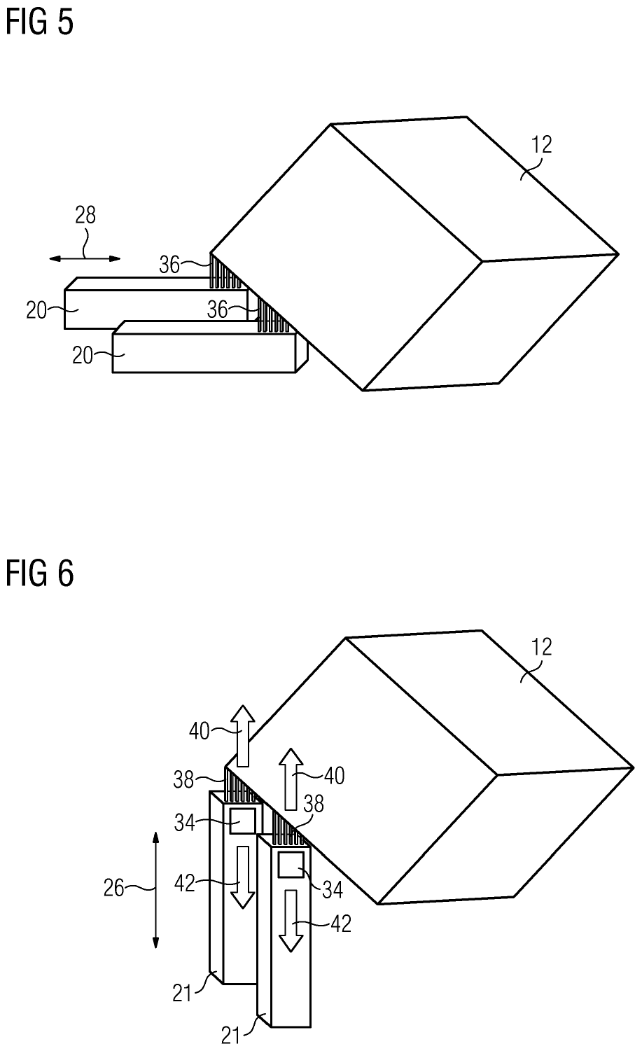

In the comparison of the two caps 30 and 32, it is shown that the cap 30 covers a larger region of the bar element than the cap 32. The caps 32 can be kept relatively short if, for example, the device 10 is operated so that support structures 38 (FIG. 6) are only arranged on the bar elements 21 on the end faces 29 thereof. The quantity of the material from which the cap 32 is manufactured, and thus the costs, can therefore be kept low.

FIG. 5 shows a detail of a schematic perspective view of a fifth embodiment of the device 10. Support structures 36, which support the shaped body 12, in particular directly, are attached to the bar elements 20 shown, which are translationally movable along the horizontal movement direction 28.

FIG. 6 shows a detail of a schematic perspective view of a sixth embodiment of the device 10. The abovementioned support structures 38, which support the shaped body 12, are attached on the bar elements 21 shown, which are translationally movable in the vertical movement direction 26.

The support structures 36 and 38 shown in FIG. 5 and FIG. 6 may be used to support the shaped body 12 during the additive manufacturing. A deformation of the shaped body during the production can thus be counteracted with the aid of the support structures 36 and/or 38. For this purpose, the support structures and 38 are produced by the additive manufacturing or the additive manufacturing method during the additive manufacturing, like the shaped body itself, in the process chamber 14 from the material from which the shaped body 12 is produced. To implement this particularly cost-effectively, the bar elements 20 are to be placed close to the shaped body 12, for example. Material can thus be saved, since the support structures 36 and 38 can be formed particularly compactly.

For example, tensions can occur in the shaped body 12 during the manufacturing of the shaped body 12, for example, due to a temperature gradient. These tensions can be detected by means of the sensors 34. The tensions in the shaped body 12 result, for example, in forces or torques acting on the bar elements 20, which can be detected by means of the sensors 34. These forces detectable by means of the sensors 34 are illustrated in FIG. 6 by force arrows 40. The support structures 38 can be used to counteract the transmitted forces and thus the tensions, which is illustrated in FIG. 6 by force arrows 42. An undesired, excess deformation of the shaped body 12 can thus be avoided and/or reduced.

What is claimed is:

1. A device for the additive manufacturing of a shaped body, the device comprising:
a process chamber for a material for making the shaped body;
a plurality of bar elements defining at least a partial region of the process chamber, wherein each of the plurality of bar elements is movable in relation to one another; and
a sensor associated with at least one of the plurality of bar elements detecting forces and/or torques acting on the at least one bar element.

2. The device as claimed in claim 1, wherein the bar elements each have a respective longitudinal extension direction and are translationally movable in relation to one another along the respective longitudinal extension direction thereof.

3. The device as claimed in claim 1, wherein at least one of the plurality of bar elements indirectly supports the shaped body during the manufacturing.

4. The device as claimed in claim 1, wherein at least one of the plurality of bar elements adjusts the temperature of the shaped body.

5. The device as claimed in claim 4, further comprising a duct extending within the at least one bar element through which a fluid for temperature control of the shaped body flows.

6. The device as claimed in claim 4, further comprising a heating element disposed at least partially within the at least one bar element.

7. The device as claimed in claim 1, further comprising a vibration unit configured to vibrate at least one of the bar elements in relation to the process chamber.

8. The device as claimed in claim 1, wherein:
at least one of the bar elements includes an end region with a free end protruding into the process chamber; and
the end region is disposed within a cap.

9. The device as claimed in claim 8, wherein:
the cap comprises a first material; and
the shaped body is formed by additive manufacturing of the first material.

10. The device as claimed in claim 1, wherein the sensor is disposed on the cap.

11. The device as claimed in claim 9, wherein the sensor detects traction forces.

12. The device as claimed in claim 1, wherein the sensor provides a signal characterizing the detected forces and/or torques; and
the device comprises an electronic processing unit to receive the signal and to move the bar elements in dependence on the signal.

13. A method for the additive manufacturing of a shaped body, the method comprising:
forming the shaped body using a material accommodated in a process chamber by additive manufacturing;
wherein at least a partial region of the process chamber is delimited by a plurality of bar elements which moved in relation to one another; and
measuring forces and/or torques acting on at least one bar element from the plurality of bar elements with a sensor associated with the at least one bar element.
